(19) United States
(12) Patent Application Publication
(10) Pub. No.: US 2012/0006848 A1
(43) Pub. Date: Jan. 12, 2012

(54) DISPENSER WITH AUTOMATIC PUMP OUTPUT DETECTION SYSTEM

(75) Inventor: AARON R. REYNOLDS, North Canton, OH (US)

(73) Assignee: GOJO Industries, Inc.

(21) Appl. No.: 12/831,376

(22) Filed: Jul. 7, 2010

(51) Int. Cl. B67D 1/00

(52) U.S. Cl. 222/63; 222/333

(57) ABSTRACT

A dispenser with an automatic pump output detection system includes a controller that controls the operation of an actuator that moves in a first and second direction along a path. A limit stop is adjustably disposed along the path, such that when the actuator moves in the first direction, it engages the limit stop and the pump. Upon engaging the limit stop, the controller reverses the movement of the actuator so that it moves in the second direction. As such, the specific discrete position of the limit stop determines the amount of material dispensed from the pump.

### TECHNICAL FIELD

The present invention generally relates to dispensers that dispense material, such as soap dispensers. Particularly, the present invention relates to a dispenser that automatically detects the amount of material to be dispensed or output by identifying the position of a mechanical limit stop.

### BACKGROUND OF THE INVENTION

Liquid dispensers are configured with a pump that dispenses a predetermined amount of material, such as soap, during each actuation. However, instances arise in which the amount of material output by the dispenser pump requires modification. For example, in the case where moisturizer is substituted for soap, it may be desirable to adjust the quantity of material dispensed by the pump so that a smaller quantity of moisturizer is dispensed in comparison to the quantity of soap originally dispensed. In addition to the ability to adjust the amount or quantity of material that is dispensed or output by the dispenser, many dispensers are configured to utilize the amount of material that is dispensed by the pump to calculate various information relating to the usage of the dispenser, such as the anticipated time for replacement of the refill container and anticipated replacement interval for the batteries used to power the dispenser. However, in order to identify that the amount of material output by the dispenser pump has been changed, a manual switch associated with a dispenser control unit is actuated to indicate that the modification has been made. Unfortunately, in many instances, users of such dispensers forget to actuate the manual switch after the output quantity of the pump has been modified, thereby preventing the dispenser from accurately dispensing the changed or modified output quantity.

In addition, to modify the amount of material dispensed, current dispenser designs require that the complete actuator mechanism be replaced with one that dispenses the desired quantity of material. Unfortunately, such a process is costly and time consuming, and in many cases such a process is prohibitive when multiple dispensers need to be modified.

Therefore, there is a need for a dispenser with an automatic pump output detection system that automatically detects when a change in the amount of material to be dispensed is set at the dispenser. In addition, there is a need for a dispenser with an automatic pump output detection system that adjusts the amount of material dispensed by the dispenser that is based on the automatic detection of a limit stop.

### SUMMARY OF THE INVENTION

In light of the foregoing, it is a first aspect of the present invention to provide a dispenser for dispensing material from a refill container comprising a motorized actuator configured to move along a path in a first direction; a pump adapted to be fluidly coupled to the refill container and configured to be engaged by said actuator when moved in said first direction; a limit stop disposed on said path to engage said actuator when said actuator is moved in said first direction; and a controller coupled to said actuator to control its movement, wherein said actuator is moved in said first direction to engage said limit stop and said pump to dispense a predetermined amount of material from said pump.

It is another aspect of the present invention to provide a dispenser for dispensing material from a refill container comprising a refill container carrying an amount of material; a motorized actuator configured to move along a path in a first direction; a pump adapted to be fluidly coupled to said refill container and configured to be engaged by said actuator when moved in said first direction; a limit stop disposed on said path to engage said actuator when said actuator is moved in said first direction; a data tag configured to send a wireless command signal identifying a position of said limit stop that is associated with a predetermined amount of material to be dispensed; a motor drive operatively coupled to said limit stop to move its position; and a controller coupled to said actuator and said motor drive, wherein said controller commands said motor drive to move said limit stop to said position upon receipt of said command signal, wherein when said actuator is moved in said first direction to engage said limit stop and said pump to dispense a predetermined amount of material from said pump.

Yet another aspect of the present invention is to provide a method of dispensing material from a dispenser comprising providing a dispenser having a motorized actuator that slideably engages a pump that is configured to dispense material from a refill container, wherein said pump and said actuator are separated by an adjustable limit stop, the position of which determines the quantity of material dispensed by said pump; adjusting said limit stop to a position associated with a desired quantity of material to be dispensed; moving said actuator in a first direction to engage said pump until said actuator contacts said limit stop; and dispensing a predetermined amount material via said pump.

### BRIEF DESCRIPTION OF THE DRAWINGS

These and other features and advantages of the present invention will become better understood with regard to the following description, appended claims, and accompanying drawings where:

FIG. 1 is a block-diagram of a dispenser with an automatic pump output detection system in accordance with the concepts of the present invention;

FIG. 2 is a front elevational view of the dispenser shown in FIG. 1 in accordance with the concepts of the present invention.

FIG. 3 is a block-diagram of another embodiment of the dispenser with an automatic pump output detection system in accordance with the concepts of the present invention; and

FIG. 4 is a block-diagram of an alternative embodiment of the dispenser with an automatic pump output detection system in accordance with the concepts of the present invention.

### BEST MODE FOR CARRYING OUT THE INVENTION

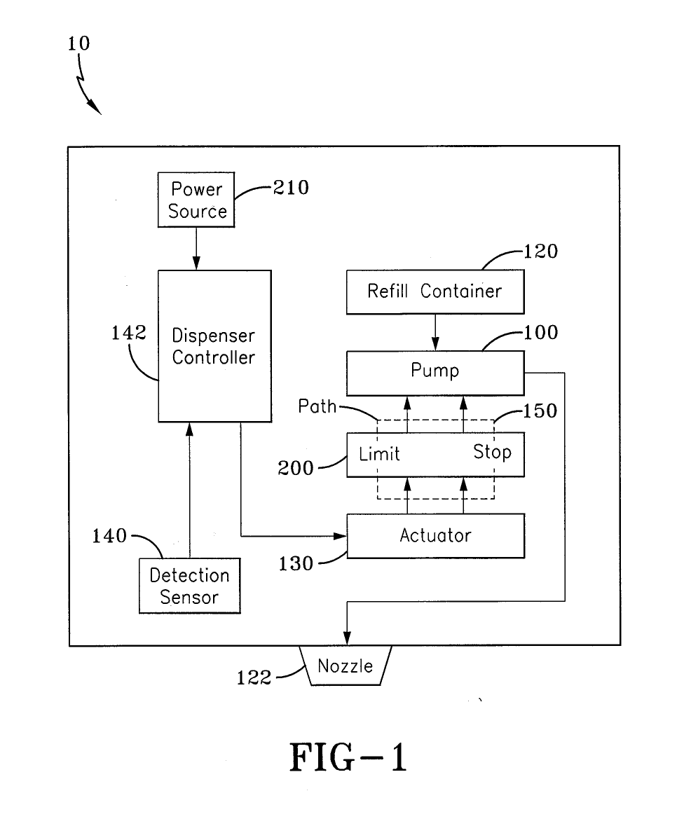

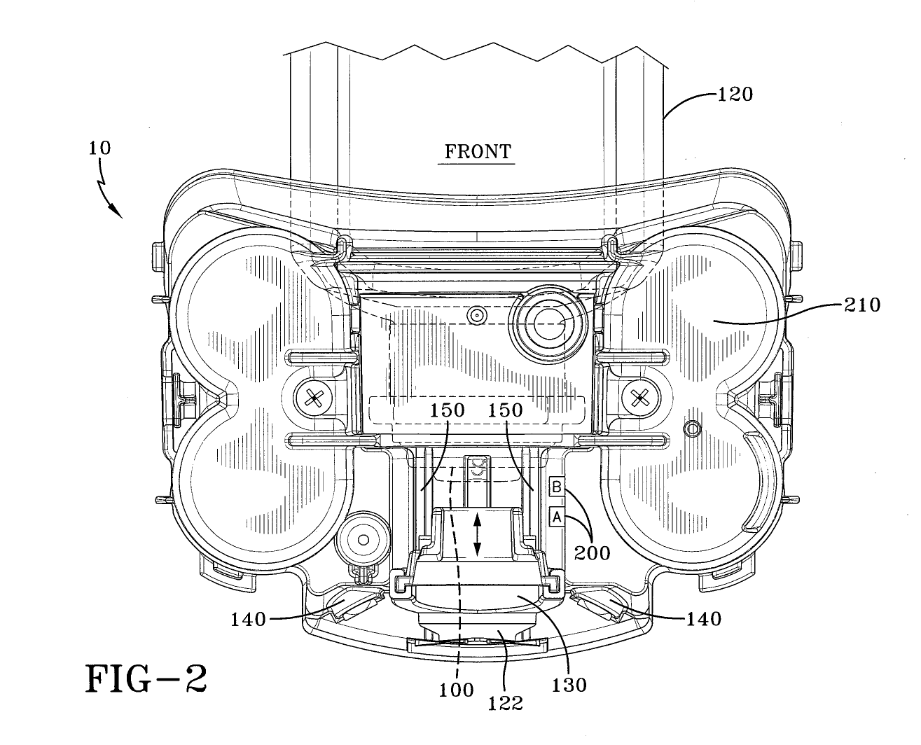

A dispenser with an automatic pump output detection system is generally referred to by the numeral 10, as shown in FIGS. 1 and 2 of the drawings. The dispenser 10 includes a pump 100 that is in fluid communication with a refill container 120 that carries an amount of material, such as soap, sanitizer, moisturizer, or any other suitable material. The pump 100 is configured to dispense a varying amount of material from the refill container 120 via a nozzle 122 when operatively engaged by a motorized actuator 130. The movement of the actuator 130 is initiated upon the detection of a hand or other body portion of a user by a detection sensor 140. The detection sensor 140 may comprise any suitable hands-free sensor, including an IR (infrared sensor), a biometric sensor, or the like. In addition, a dispenser controller 142 is coupled to the actuator 130 and the detection sensor 140 and includes the necessary hardware, software, and memory necessary for carrying out the functions to be discussed. Additionally, the controller 142 may be configured as an application specific (ASIC) or general purpose computing unit.

The motorized actuator 130 is configured to move in opposed first and second directions along a path 150. The actuator 130 is arranged to engage the pump 100 in order to dispense material from the refill container 120 that is in fluid communication with the nozzle 122. That is, as the actuator 130 applies a force to the pump 100, it causes it to dispense an amount of material from the refill container 120. As such, the amount of material dispensed by the dispenser 10 is dependent on the amount or extent in which the actuator 130 engages the pump 100. In one aspect, the pump 100 may comprise a unit dose piston pump, which is configured to dispense a fixed or predetermined amount of material when the pump 100 is fully depressed or engaged (full stroke). Correspondingly, when the pump 100 is partially depressed or engaged (short stroke) a partial amount of material, less than that dispensed during a full stroke of the pump 100, is dispensed. As such, the dispenser 10 takes advantage of this functionality by providing a method of short stroking the pump 100 to dispense a predetermined or desired amount of material.

Continuing, upon the detection of the user's hand via the detection sensor 140, the motorized actuator 130 moves forward along the path 150 to engage the pump 100 and then returns back to an initial position. In order to control the amount of material dispensed by the pump 100, a limit stop 200 is disposed at a predetermined point along the path 150 of travel taken by the actuator 130 to physically contact the actuator 130, thereby impeding its movement. The resistance in movement of the actuator 130 imparted by the limit stop 200 is detected by the controller 142, which then automatically reverses the movement of the actuator 130, causing it to disengage from the pump 100. That is, the limit stop 200 is disposed along the path 150 between the pump 100 and the actuator 130 and is configured to be manually adjusted or positioned to a discrete position that corresponds to predetermined quantities of material to be dispensed by the pump 100. It should be appreciated that the limit stop 200 may be attached to the dispenser 10 using a tab that is configured to snap-fit into one of a plurality of receiving pockets or apertures. Alternatively, the limit stop 200 may be configured so that it could be unlocked and moved in a different position, so that a different amount of material from the refill container 120 can be dispensed. In addition, the limit stop 200 may comprise a rotating section from which extends an arm that acts as the limit stop, so that one or more various amounts of material can be dispensed from the refill container 120. Specifically, the limit stop 200 comprises a tab or other obstacle that limits the amount that the actuator 130 contacts or engages the pump 100. As a result, because the actuator 130 is limited in the extent to which it is able to contact the pump 100 by the position of the limit stop 200, the amount of material that is dispensed by the dispenser 10 is controlled. That is, the stroke or movement of the actuator 130 in the first direction is limited by the position of the limit stop 200, and, therefore, each discrete position of the limit stop 200 corresponds to a specific amount of material that is dispensed from the refill container 120 by the pump 100. For example, as shown in FIG. 2, by placing the limit stop 200 in a first position, designated “A”, the dispenser 10 outputs 0.40 ml of material, and when the limit stop 200 is placed in a second position, designated “B”, the dispenser 10 outputs 0.60 ml of material. Thus, the particular placement of the limit stop 200 along the path determines the specific amount of material that is to be dispensed from the refill container 120. It should be appreciated that regardless of the position of the limit stop 200, the controller 142 identifies when the actuator 130 has contacted the limit stop 200 by monitoring and identifying when the amount of electrical current consumed by the motorized actuator 130 exceeds a predetermined magnitude or threshold value.

To power the components of the dispenser 10, including the controller 142, motorized actuator 130, and detection sensor 140, a portable power source 210, such as a battery, comprising rechargeable or non-rechargeable batteries, is coupled to the controller 142.

Thus, with the components of the dispenser 10 set forth, the following discussion will present its particular manner of operation. Initially, prior to placing the dispenser 10 into operation, the user manually adjusts the limit stop 200 to the position that corresponds to the desired amount of material to be dispensed from the refill container 120. Once the limit stop 200 has been moved to the desired discrete position, a user is permitted to place his or her hand in proximity of the dispenser 10 for detection by the detection sensor 140. Upon the detection of the user's hand by the detection sensor 140, the controller 142 initiates the movement of the actuator 130 in its first direction along the path 150. As the actuator 130 moves in the first direction, it impinges or otherwise applies an amount of force to the pump 100 by an amount that is limited by the limit stop 200. That is, the limit stop 200 restricts the amount in which the actuator 130 is permitted to physically contact the pump 100, therefore dispensing a predetermined amount of material that corresponds to the position of the limit stop 200. Furthermore, as the actuator 130 engages the limit stop 200 and its movement gradually slows or pauses/stops, the controller 142 monitors the electrical current that is consumed by the actuator 130. Upon the detection of an electrical current spike that has reached a predetermined magnitude or threshold value, the controller 142 reverses the movement of the actuator 130 so that it moves in a second direction. That is, the controller 142 detects the pause in motion of the actuator 130 as it moves in a first direction by identifying when the amount of electrical current that is consumed by the actuator 130 reaches a predetermined magnitude or threshold. Once this electrical current threshold is detected, which indicates the pause or stop of the actuator 130 due to its contact with the limit stop 200, the controller 142 moves the actuator 130 in a second direction away from said limit stop 200 and the pump 100, so that the actuator 130 is disengaged from the limit stop 200 and the pump 100.

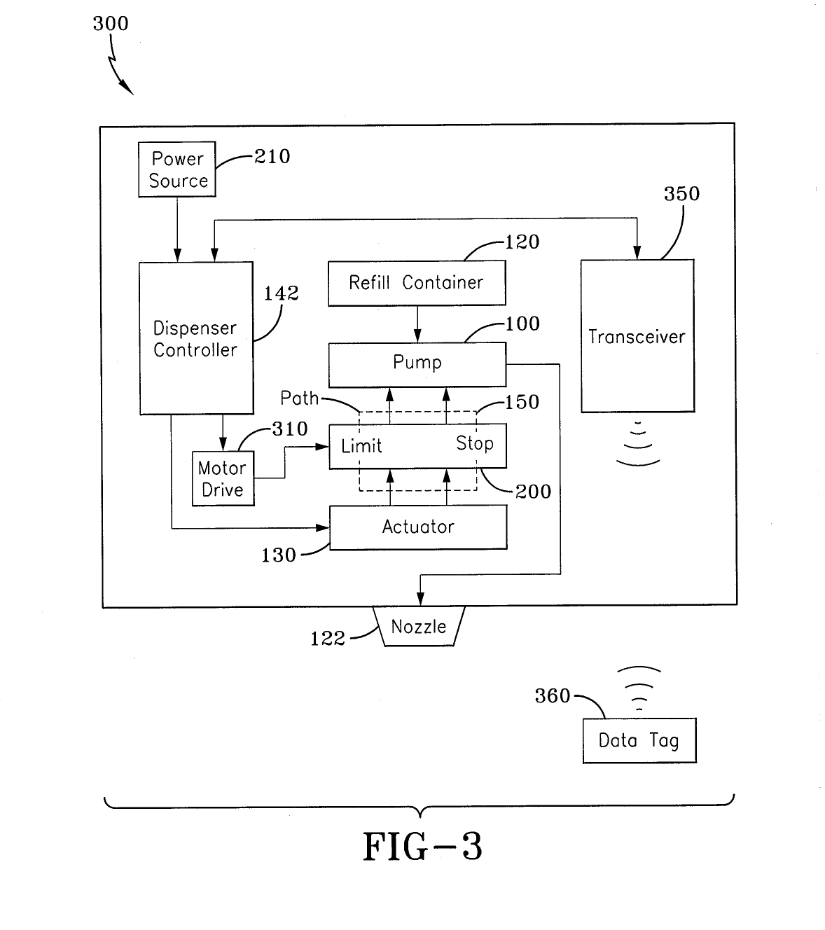

In yet another embodiment, as shown in FIG. 3, a dispenser with an automatic pump output detection system, referred to by the numeral 300, may also include a motor drive unit 310 that is operatively coupled to the limit stop 200, allowing it to be moved automatically. In addition, a transceiver 350 is coupled to the controller 142, such that the transceiver 350 is configured to communicate with a data tag 360 that stores a predetermined dispensing quantity value. For example, the transceiver 350 may comprise an RFID (radio frequency identification) reader that is capable of receiving data transmitted from the data tag 360 that comprises an RFD) tag. The data tag 360 is carried or worn by an individual and is detected by the transceiver 350 when the user is within its range of reception. Once detected, the dispensing quantity value is wirelessly communicated from the data tag 360 via a data message to the transceiver 350, whereupon the controller 142 commands the motor drive 310 to move the limit stop 200 to a position along the path 150 that corresponds to that of the dispensing quantity that is stored and communicated to the dispenser 300 by the data tag 360. Thus, the dispenser 10 is able to dynamically adjust the amount of material that is output from the refill container 120 based on the quantity value that is stored in the data tag 360 worn by various individuals.

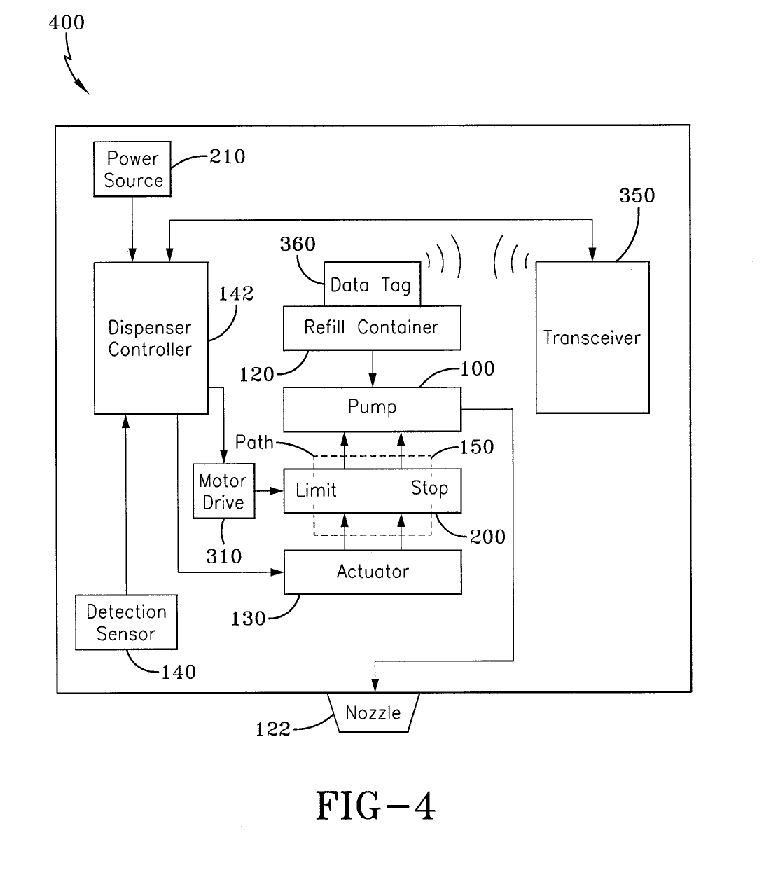

In yet another embodiment, as shown in FIG. 4, the dispenser 300 may comprise a system in which the refill container 120 includes the data tag 360 directly thereon. As such, each time a new refill container 120 is installed into the dispenser 300, the dispensing quantity value stored at the data tag 360 is communicated to the transceiver 350 via a data message. For example, various refill containers 120 may contain different types of materials, such as soap, sanitizer, and moisturizer, with each material type having a different dispensing quantity value associated with it, such as 0.50 ml, 0.70 ml, and 0.80 ml, respectively. For example, a soap-carrying refill container 120 that is installed at the dispenser 300 commands the limit stop 200 to move to a position along the path 150 that corresponds to an output of 50 ml, while a moisturizer-carrying refill container 120 commands the limit stop 200 to move to a position along the path 150 that corresponds to an output of 60 ml. As such, the amount of material dispensed from the dispenser 300 is able to be dynamically customized depending on the particular materials that are to be dispensed.

It will, therefore, be appreciated that one advantage of one or more embodiments of the present invention is that a dispenser with an automatic pump output detection system allows the dispenser to adjust the amount of material output by the dispenser. Another advantage of the present invention is that the automatic pump output detection system allows the amount of material dispensed by the dispenser to be adjusted automatically upon the receipt of a dispensing quantity value wirelessly sent from a data tag. Still another advantage of the present invention is that the automatic pump output detection system allows the amount of material output from the dispenser to be changed without replacing dispensers.

Although the present invention has been described in considerable detail with reference to certain embodiments, other embodiments are possible. Therefore, the spirit and scope of the appended claims should not be limited to the description of the embodiments contained herein.

What is claimed is:

1. A dispenser for dispensing material from a refill container comprising:
a motorized actuator configured to move along a path in a first direction;
a pump adapted to be fluidly coupled to the refill container and configured to be engaged by said actuator when moved in said first direction;
a limit stop disposed on said path to engage said actuator when said actuator is moved in said first direction; and
a controller coupled to said actuator to control its movement;
wherein, said actuator is moved in said first direction to engage said limit stop and said pump to dispense a predetermined amount of material from said pump.

2. The dispenser of claim 1, wherein said actuator is moved in a second direction along said path to disengage from said limit stop and said pump.

3. The dispenser of claim 1, wherein said controller monitors the electrical current consumed by said actuator, said controller moving said actuator in a second direction along said path to disengage from said limit stop and said pump when said electrical current reaches a predetermined magnitude.

4. The dispenser of claim 1, wherein said limit stop is adjustably positioned on said path.

5. The dispenser of claim 1, wherein said controller is configured to wirelessly communicate with a data tag, said tag communicating a message thereto to command said limit stop to move to a position corresponding to a predetermined amount of material output by said pump.

6. The dispenser of claim 5, wherein said tag comprises an RFID tag.

7. A dispenser for dispensing material from a refill container comprising:
a refill container carrying an amount of material;
a motorized actuator configured to move along a path in a first direction;
a pump adapted to be fluidly coupled to said refill container and configured to be engaged by said actuator when moved in said first direction;
a limit stop disposed on said path to engage said actuator when said actuator is moved in said first direction;
a data tag configured to send a wireless command signal identifying a position of said limit stop that is associated with a predetermined amount of material to be dispensed;
a motor drive operatively coupled to said limit stop to move its position; and
a controller coupled to said actuator and said motor drive, wherein said controller commands said motor drive to move said limit stop to said position upon receipt of said command signal;
wherein, when said actuator is moved in said first direction to engage said limit stop and said pump to dispense a predetermined amount of material from said pump.

8. The dispenser of claim 7, wherein said actuator is moved in a second direction along said path to disengage from said limit stop and said pump.

9. The dispenser of claim 7, wherein said controller monitors the electrical current consumed by said actuator, said controller moving said actuator in a second direction along said path to disengage from said limit stop and said pump when said electrical current reaches a predetermined magnitude.

10. The dispenser of claim 7, wherein said limit stop is adjustably positioned on said path.

11. The dispenser of claim 10, wherein said tag comprises an RFID tag.

12. The dispenser of claim 10, wherein said data tag is attached to said refill container.

13. The dispenser of claim 7, wherein said controller is configured to wirelessly communicate with a data tag, said tag communicating a message thereto to command said limit stop to move to a position corresponding to a predetermined amount of material to be dispensed by said pump.

14. A method of dispensing material from a dispenser comprising:
providing a dispenser having a motorized actuator that slideably engages a pump that is configured to dispense material from a refill container, wherein said pump and said actuator are separated by an adjustable limit stop, the position of which determines the quantity of material dispensed by said pump;
adjusting said limit stop to a position associated with a desired quantity of material to be dispensed;
moving said actuator in a first direction to engage said pump until said actuator contacts said limit stop; and
dispensing a predetermined amount material via said pump.

15. The method of claim 14, further comprising moving said actuator in a second direction away from said pump.

16. The method of claim 14, further comprising:
monitoring electrical current consumed by said actuator; and
moving said actuator in a second direction away from said pump to disengage from said limit stop and said pump when said electrical current reaches a predetermined magnitude.
